(19) United States
(12) Patent Application Publication
(10) Pub. No.: US 2021/0096877 A1
(43) Pub. Date: Apr. 1, 2021

(54) COLLAPSING BUBBLES IN A PROCESSING UNIT PIPELINE

(71) Applicant: ADVANCED MICRO DEVICES, INC., Santa Clara, CA (US)

(72) Inventors: Bin HE, Orlando, FL (US); Michael MANTOR, Orlando, FL (US); Jiasheng CHEN, Orlando, FL (US)

(21) Appl. No.: 16/583,969

(22) Filed: Sep. 26, 2019

(51) Int. Cl. G06F 9/38; G06F 7/57

(52) U.S. Cl. CPC G06F 9/3869; G06F 7/57

(57) ABSTRACT

An arithmetic logic unit (ALU) pipeline of a processing unit collapses execution bubbles in response to a stall at a stage of the ALU pipeline. An execution bubble occurs at the pipeline in response to an invalid instruction being placed in the pipeline for execution. The invalid instruction thus consumes an available “slot” in the pipeline, and proceeds through the pipeline until a stall in a subsequent stage (that is, a stage after the stage executing the invalid instruction) is detected. In response to detecting the stall, the ALU continues to execute instructions that are behind the invalid instruction in the pipeline, thereby collapsing the execution bubble and conserving resources of the ALU.in response to a stall at a stage of the ALU pipeline.

### BACKGROUND

A processor can employ one or more processing units that are specially designed and configured to perform designated operations on behalf of the processor. For example, a processor can employ a graphics processing unit (GPU) to perform graphics and vector processing operations. A central processing unit (CPU) of the processor provides commands to the GPU, and a command processor (CP) of the GPU decodes the commands into one or more instructions. Execution units of the GPU, such as one or more arithmetic logic units (ALUs), execute the instructions to perform the graphics and vector processing operations. To further enhance processing efficiency, the execution units can pipeline execution of the instructions. However, conventional execution units can experience execution “bubbles” wherein an execution unit experiences one or more processing cycles whereby a stage of the execution unit is not performing useful work.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing unit that collapses execution bubbles at stages of an ALU in response to execution stalls in accordance with some embodiments.

FIG. 2 is a block diagram illustrating an example of the processing unit of FIG. 1 collapsing an execution bubble in accordance with some embodiments.

FIG. 3 is a block diagram illustrating another example of the processing unit of FIG. 1 collapsing an execution bubble in accordance with some embodiments.

FIG. 4 is a block diagram illustrating another example of the processing unit of FIG. 1 collapsing an execution bubble in accordance with some embodiments.

FIG. 5 is a flow diagram of a method of collapsing an execution bubble at an ALU of a processor in accordance with some embodiments.

### DETAILED DESCRIPTION

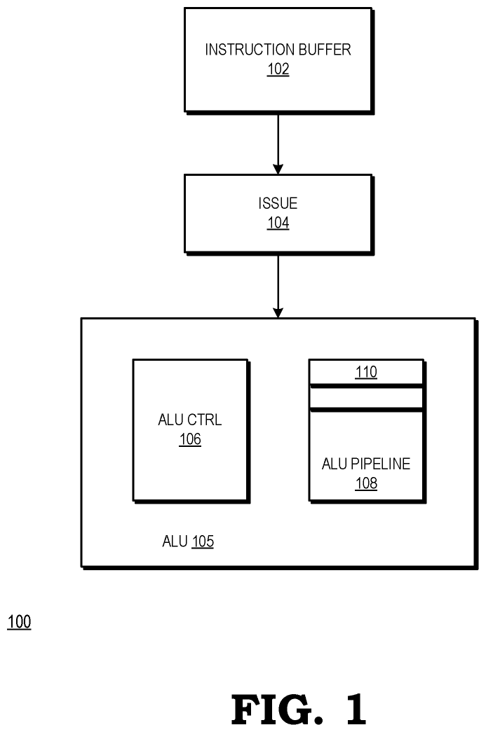

FIGS. 1-5 illustrate techniques for collapsing execution bubbles at arithmetic logic unit (ALU) pipeline of a processing unit in response to a stall at a stage of the ALU pipeline. An execution bubble occurs at the pipeline in response to an invalid instruction being placed in the pipeline for execution. The invalid instruction thus consumes an available “slot” in the pipeline, and proceeds through the pipeline until a stall in a subsequent stage (that is, a stage after the stage executing the invalid instruction) is detected. In response to detecting the stall, the ALU continues to execute instructions that are behind the invalid instruction in the pipeline, thereby collapsing the execution bubble and conserving resources of the ALU.

To illustrate, a conventional ALU maintains an execution bubble in the pipeline until the invalid instruction exits the last stage of the pipeline. That is, in a conventional ALU the invalid instruction is executed at each stage of the pipeline, thereby consuming power and other processing unit resources until the invalid instruction exits the pipeline. In contrast, using the techniques described herein, the execution bubble is collapsed during a pipeline stall, effectively discarding the invalid instruction from the pipeline before the invalid instruction reaches the last stage of the pipeline. The invalid instruction is therefore not executed at every stage of the instruction pipeline, conserving power and other processor resources.

FIG. 1 illustrates a portion of a processing unit 100 that is able to collapse execution bubbles at a pipeline in accordance with some embodiments. For purposes of description, it is assumed that the processing unit 100 is part of a processor that executes sets of instructions (e.g. computer programs) to carry out tasks on behalf of an electronic device. Thus, in different embodiments the processing unit 100 is part of an electronic device such as a desktop computer, laptop computer, server, tablet, smartphone, game console, and the like. Further, it is assumed that the processor including the processing unit 100 includes a central processing unit (CPU) that executes the sets of instructions.

The processing unit 100 is designed and manufactured to carry out specified operations on behalf of the CPU. Thus, for the embodiment described with respect to FIG. 1, the processing unit 100 is assumed to be a graphics processing unit (GPU) that performs graphics and vector processing operations on behalf of the CPU. For example, in some embodiments, in the course of executing instructions the CPU generates commands associated with graphics and vector processing operations. The CPU provides the commands to the processing unit 100, which employs a command processor (not shown) to decode the commands into sets of operations. The processing unit 100 includes a plurality of compute units to execute the operations generated by the command processor.

To facilitate execution of operations, the processing unit 100 includes an instruction buffer 102, and issue stage 104, and an arithmetic logic unit (ALU) 105. In some embodiments, one or more of the instruction buffer 102, the issue stage 104, and the ALU 105 are shared among multiple compute units while in other embodiments each compute unit includes its own instruction buffer, issue stage, and ALU. In the course of executing operations, a CPU generates a set of instructions, referred to as ALU instructions, to be executed at the ALU 105. Examples of ALU instructions include add instructions, multiply instructions, matrix manipulation instructions, and the like. The compute unit stores the ALU instructions at the instruction buffer 102 for execution. The issue stage 104 controls one or more pointers that point to entries of the instruction buffer 102. The issue stage 104 manipulates the pointers to read instructions from the instruction buffer and provide the read instructions to the ALU 105. The reading of an instruction from the instruction buffer 102 and provision of the instruction to the ALU 105 is referred to as “issuing” the instruction to the ALU 105.

The ALU 105 executes the issued instructions to carry out mathematical operations defined by the instructions. To facilitate execution of the instructions, the ALU 105 includes an ALU control module 106 and an ALU pipeline 108. The ALU pipeline 108 includes a plurality of pipeline stages (e.g. stage 110) wherein each stage carries out one or more operations based on the instruction being executed and in particular based on data provided by the previous stage of the ALU pipeline 108. Thus, an issued instruction begins execution at an initial stage of the ALU pipeline 108, the initial stage provides the results of the execution to the second stage which executes operations based the received data and provides the results to the third stage, and so on until the instruction reaches a final stage of the ALU pipeline 108, which stores a final result of the operation at a register file (not shown) or other storage location of the processing unit 100. Further, the ALU pipeline 108 executes instructions in a pipelined fashion, such that each stage of the ALU pipeline 108 concurrently executes a different instruction. That is, for a given cycle of the ALU pipeline 108, the initial stage executes one instruction, the second stage another instruction, the third stage still another instruction, and so on.

The ALU control module 106 monitors conditions at the ALU pipeline 108 and, based on the monitored conditions, controls which stages execute instructions for a given cycle. That is, in some embodiments the ALU control module 106 controls gating of clock signals and other control signals to determine, for a given cycle, which stages of the ALU pipeline 108 execute instructions. For example, under some conditions a stage of the ALU pipeline 108 will enter a stall condition, wherein the stage is awaiting operations at another execution unit before the stage can proceed, such as awaiting data from a cache or awaiting preparation of a cache line to store data. The ALU control module 106 detects the stall condition at the stage and suspends execution at other stages of the ALU pipeline 108 while the stall condition persists, thereby preventing instructions from proceeding to the stalled stage and causing execution errors.

Under some conditions, the ALU pipeline 108 is provided with an invalid instruction, wherein the result of the instruction is expected to be invalid and will not be used by the processing unit. For example, in some embodiments an instruction provided to the ALU pipeline 108 has an unresolved data dependency (e.g., a dependency on another instruction that has not completed execution), and the instruction is therefore invalid. In other embodiments an instruction provided to the ALU has a register conflict with another instruction, such that it is unknown whether the ALU instruction has been provided with the correct data, causing the ALU instruction to be invalid.

Because the invalid instruction does not generate useful data, the instructions location at the ALU pipeline 108 as it proceeds is referred to as an execution bubble. Under normal conditions, it is not efficient for the ALU 105 to discard the invalid instruction from the ALU pipeline 108, such that the bubble proceeds through each stage of the pipeline. In particular, under normal conditions, each instruction (including the instruction corresponding to the bubble) is processed at the corresponding stage of the pipeline during an execution cycle, then proceeds to the next stage. The processing bubble is able to be collapsed by halting execution of instructions at pipeline stages subsequent to the bubble while continuing processing of instructions at pipeline stages behind the bubble. The results of processing the invalid instruction are discarded and the pipeline state information associated with the bubble is overwritten, thereby effectively removing the invalid instruction from the pipeline and collapsing the bubble. Thus, under normal conditions, collapsing the bubble requires temporarily halting processing of the instructions at the pipeline stages that are subsequent to the bubble, reducing processing efficiency for the halted instructions and providing no overall increase in pipeline efficiency. However, when there is a stall at a pipeline stage subsequent to the execution bubble, execution of instructions at the stages subsequent to the bubble are already halted due to the stall, such that the execution bubble is able to be collapsed without a performance penalty. Thus, in response to detecting 1) a stall condition at a stage of the ALU pipeline, 2) an execution bubble prior to the stalled stage, the ALU control module 106 suspends execution at the execution bubble stage but allows execution at the pipeline stages prior to the execution bubble to proceed, thereby overwriting the data associated with the bubble at registers and other logic elements of the stage associated with the bubble. The invalid instruction is thereby effectively discarded from the ALU pipeline 108 and the execution bubble associated with the invalid instruction is collapsed. By collapsing the execution bubble, the ALU control module increases the amount of useful work performed by the ALU 105, and thus increases the overall processing efficiency of the processing unit 100.

In some embodiments, the stall condition is detected in any of a number of ways. For example, in some embodiments, each stage of the ALU pipeline includes circuitry to detect: 1) whether the instruction being executed at the pipeline stage is dependent on another instruction or other operation (referred to as the source instruction) being executed at another module of the GPU 100 and 2) if the instruction being executed is a dependent instruction, whether the source instruction has completed execution. In response to the source instruction having not completed execution, the ALU pipeline stage sends control signaling to the ALU control module 106. In response to the control signaling, the ALU control module 106 indicates a stall to the other stages of the ALU pipeline 108, and initiates collapsing of execution bubbles as described herein.

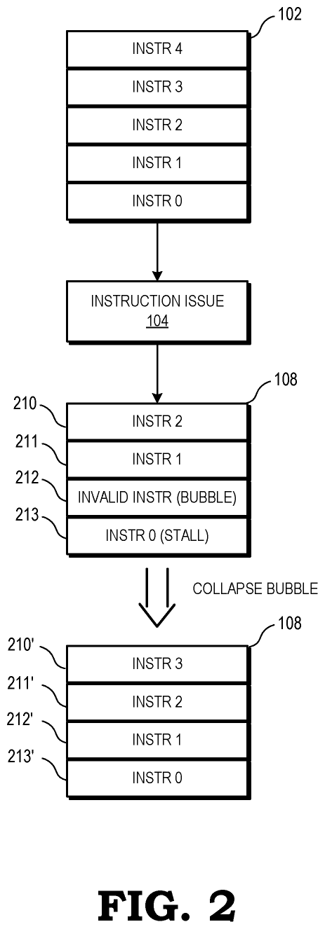

FIG. 2 illustrates an example of the processing unit 100 collapsing an execution bubble at the ALU 105 in accordance with some embodiments. In the depicted example, the ALU pipeline 108 includes four stages, designated stages 210, 211, 212, and 213 respectively. Further, the instruction buffer 102 stores five ALU instructions, designated INSTR 0, INSTR 1, INSTR 2, INSTR 3, and INSTR 4. The instruction issue stage has issued instructions so that at a given cycle, stage 210 is executing INSTR 2, stage 211 is executing INSTR 1, and stage 213 is executing INSTR 0. Further, an invalid instruction has been placed in the pipeline 108, such that stage 212 (between stages 211 and 213) is executing the invalid instruction. That is, there is an execution bubble at stage 212. In addition, stage 213 has entered a stall condition as it awaits a signal from another execution unit (not shown) that a designated operation has been completed.

In response to detecting both 1) the stall at stage 213 and 2) the invalid instruction at stage 212 (that is, in response to detecting the execution bubble at stage 212) the ALU control module 106 collapses the execution bubble at stage 212. In particular, the ALU control module 106 controls clock signals or other control signaling for the stages 210-213 so that execution of instructions continues at stages 210 and 211 for the next cycle, while execution of instructions is suspended at stages 212 and 213. In addition, the instruction issue stage 104 issues INSTR 3 to stage 210. The result is that, following the execution cycle, stage 210 (illustrated as 210′ to denote the state of the stage after the bubble is collapsed) is executing INSTR 3, stage 211 (illustrated as 211′) is executing INSTR 2, stage 212 (illustrated as 212′) is executing INSTR 1, and stage 213 (illustrated as 213′) is executing INSTR 0, which is no longer stalled. Thus, the invalid instruction has been removed from the ALU pipeline 108, allowing each stage to do useful work. Further, because the execution bubble is cleared during a stall condition, overall throughput at the ALU pipeline 108 is maintained.

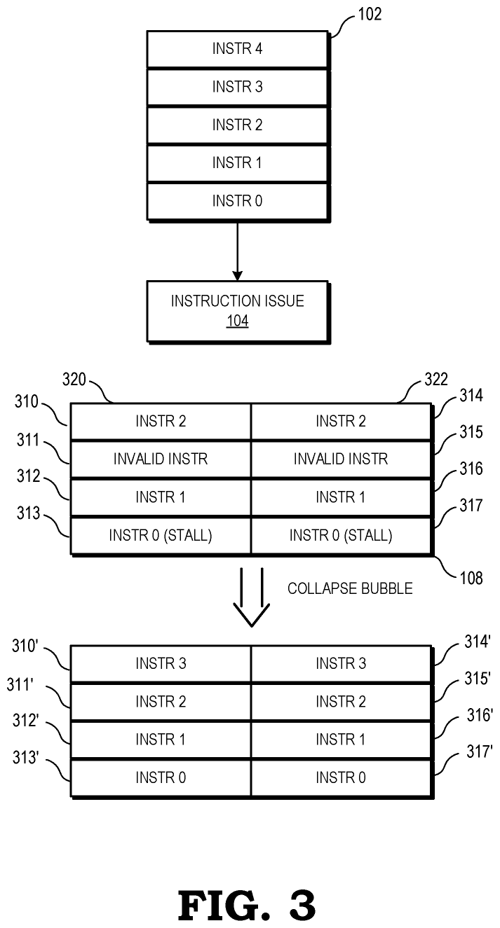

In some embodiments, the ALU pipeline 108 has multiple execution paths to perform different arithmetic operations concurrently. An example is illustrated at FIG. 3 in accordance with some embodiments. In particular, in the example of FIG. 3, the ALU pipeline 108 includes two execution paths, designated path 320 and 322. Each of the paths 320 and 322 is designed and manufactured to perform different types of mathematical operations based on received instructions. For example, in some embodiments the path 320 executes single precision operations while path 322 executes double precision operations. In other embodiments the ALU pipeline 108 includes additional paths. Further, while in the embodiment of FIG. 3 each of the paths 320 and 322 have the same number of stages, in other embodiments the paths of the ALU pipeline 108 include different numbers of stages.

In the depicted example, the paths 320 and 322 includes four stages, designated stages 310, 311, 312, and 313 (for path 320) and stages 314, 315, 316, 317, and 318 (for path 322) respectively. Further, the instruction buffer 102 stores five ALU instructions, designated INSTR 0, INSTR 1, INSTR 2, INSTR 3, and INSTR 4. Each of these instructions is executed via the different stages of the pipelines 320 and 322, with the different corresponding stages of the pipelines 320 and 322 executing different operations for a given instruction. Thus, for example, if INSTR 1 is being executed at stages 312 and 316 during a given execution cycle, in some embodiments each of the stages 312 and 316 performs different operations associated with the instruction. In other embodiments, the stages 312 and 316 perform similar operations using different operands on behalf of INSTR 1.

In the example of FIG. 3, the instruction issue stage has issued instructions so that at a given cycle, stages 310 and 314 are executing operations associated with INSTR 2, stages 312 and 315 are executing operations associated with INSTR 1, and stages 313 and 317 are executing operations on behalf of INSTR 0. Further, an invalid instruction has been placed in the pipeline 108, such that stage 311 (between stages 310 and 312) and stage 315 are executing operations on behalf of the invalid instruction so there is an execution bubble at stage 311. In addition, stages 313 and 317 have entered a stall condition.

In response to detecting both 1) the stall at stages 313 and 317 and 2) the invalid instruction at stages 311 and 315 (that is, in response to detecting the execution bubble at stages 311 and 315) the ALU control module 106 collapses the execution bubble at stages 311 and 315. In particular, the ALU control module 106 controls clock signals or other control signaling for the stages 310-313 and 314-316 so that execution of instructions continues at stages 310 and 314 for the next cycle, while execution of instructions is suspended at stages 311, 312, and 313 and at stages 315, 316, and 317. In addition, the instruction issue stage 104 issues INSTR 3 to stages 310 and 314. The result is that, following the execution cycle, stage 310 (illustrated as 310′) and stage 314 (illustrated as 314′) are executing operations on behalf of INSTR 3, stage 311 (illustrates as 311′) and stage 315 (illustrated as 315′) are executing operations on behalf of INSTR 2, stage 312 (illustrated as 312′) and stage 316 (illustrated as 316′) are executing operations on behalf of INSTR 1, and stage 313 (illustrated as stage 313′) and stage 317 (illustrated as 317′) are executing operations on behalf of INSTR 0, which is no longer stalled. Thus, the invalid instruction has been removed from the ALU pipeline 108.

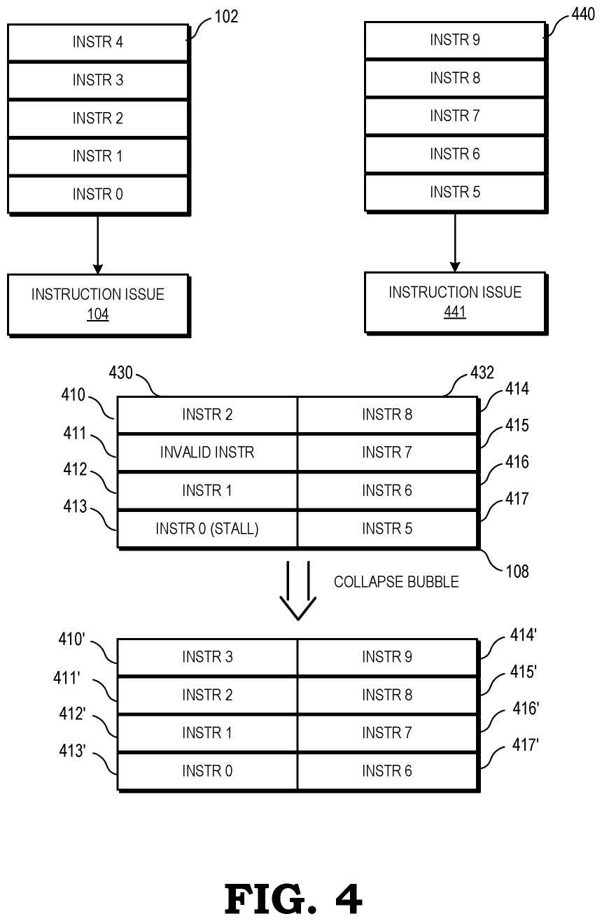

In some embodiments, the ALU pipeline 108 has multiple independent pipelines that execute different sets of instructions. An example is illustrated at FIG. 4 in accordance with some embodiments. In particular, in the example of FIG. 4, the ALU pipeline 108 includes two independent pipelines, designated pipelines 430 and 432. Each of the pipelines 430 and 432 is designed and manufactured to independently perform mathematical operations based on received instructions. In addition, in the depicted example the GPU 100 includes a second instruction buffer 440 and issue stage 441 to respectively store instructions for and issue instructions to the pipeline 432. In other embodiments, the pipelines 430 and 432 share the instruction buffer 102 and instruction issue stage 104.

In the depicted example, the pipelines 430 and 432 each include four stages, designated stages 410, 411, 412, and 413 (for pipeline 430) and stages 414, 415, 416, 417, and 418 respectively. Further, the instruction buffer 102 stores five ALU instructions, designated INSTR 0, INSTR 1, INSTR 2, INSTR 3, and INSTR 4, and the instruction buffer 440 stores five different ALU instructions, designated INSTR 5, INSTR 6, INSTR 7, INSTR 8, and INSTR 9. Each of these sets of instructions are independently executed via the different stages of the pipelines 430 and 432, respectively, as described further below.

In the example of FIG. 4, the instruction issue stage 104 has issued instructions so that at a given cycle, stage 410 is executing INSTR 2, stage 412 is executing INSTR 1, and stage 413 is executing INSTR 0. Further, an invalid instruction has been placed in the pipeline 108, such that stage 411 (between stages 410 and 412) is executing the invalid instruction so there is an execution bubble at stage 411. In addition, stage 413 has entered a stall condition. With respect to the pipeline 431, stage 414 is executing INSTR 8, stage 415 is executing INSTR 7, stage 416 is executing INSTR 6, and stage 417 is executing INSTR 5. Thus, in the depicted example, there is a stall condition at the pipeline 430, but there is not a stall condition at the pipeline 432.

Similar to the example of FIG. 3, in response to detecting both 1) the stall at stage 413 and 2) the invalid instruction at stage 411 (that is, in response to detecting the execution bubble at stage 411) the ALU control module 106 collapses the execution bubble at stages 411. In particular, the ALU control module 106 controls clock signals or other control signaling for the stages 410-413 so that execution of instructions continues at stages 410 and 414 for the next cycle, while execution of instructions is suspended at stages 411, 412, and 413. In addition, the instruction issue stage 104 issues INSTR 3 to stage 410. Furthermore, the ALU control module 106 controls the clock signals or other control signaling so that execution of instructions continues at stages 414-417 of the pipeline 432, and so that INSTR 9 is issued to the pipeline 432. The result is that, following the execution cycle, stage 410 (illustrated as 410′) is executing INSTR 3, stage 411 (illustrated as 411) is executing INSTR 2, stage 412 (illustrated as 412′) is executing INSTR 1, and stage 413 (illustrated as stage 413′) is executing INSTR 0, which is no longer stalled. Thus, the invalid instruction has been removed from the ALU pipeline 108. Further, stage 414 (illustrated as 414′) is executing INSTR 9, stage 415 (illustrated as 415′) is executing INSTR 8, stage 416 (illustrated as 416′) is executing INSTR 7, and stage 417 (illustrated as stage 417) is executing INSTR 6. Thus, in the depicted example, an execution bubble is collapsed at one pipeline in response to a stall, while execution of instructions continues normally at a different pipeline.

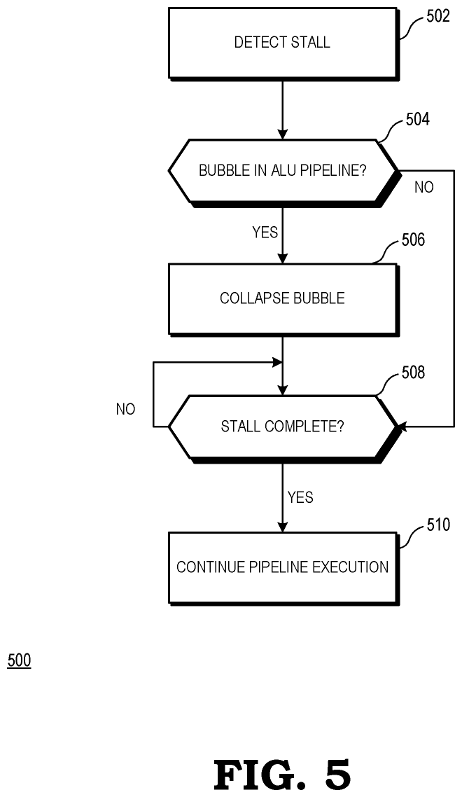

FIG. 5 illustrates a flow diagram of a method 500 of collapsing an execution bubble at an ALU of a processor in accordance with some embodiments. The method 500 is described with respect to an example implementation at the processing unit 100 of FIG. 1. At block 502, the ALU control module 106 detects a stall at one of the stages of the ALU pipeline 108. The method flow proceeds to block 504 and in response to detecting the stall the ALU control module 106 determines whether there is an execution bubble at a different stage of the ALU pipeline 108. If not, the method flow proceeds to block 508, described below.

In response to detecting a bubble at a stage of the ALU pipeline 108, the method flow moves to block 506 and the ALU control module 106 collapses the identified bubble. In particular, the ALU control module 106 controls provision of clock signals or other control signals so that, for one or more subsequent cycles, instructions are executed at the stages that are located prior to the execution bubble in the pipeline 108, and so that the execution bubble stage does not execute. This causes the invalid instruction corresponding to the bubble to be overwritten, effectively discarding data associated with the invalid instruction from the ALU pipeline 108 and collapsing the execution bubble.

The method flow proceeds to block 508 and the ALU control module 106 determines if the stall condition is complete. If not, the method flow returns to block 508 until the stall condition is complete. In response to the stall condition completing at block 508, the method flow proceeds to block 510 and the ALU control module 106 continues execution of instructions at all stages of the ALU pipeline 108.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
identifying a first execution bubble at a first stage of an arithmetic logic unit (ALU) and a first stall condition at a second stage of the ALU; and
in response to identifying the first execution bubble and the first stall condition, collapsing the first execution bubble.

2. The method of claim 1, wherein:
collapsing the first execution bubble comprises executing a first instruction at a third stage of the ALU during the first stall condition.

3. The method of claim 2, wherein:
collapsing the first execution bubble comprises executing a second instruction at a fourth stage of the ALU during the first stall condition.

4. The method of claim 2, wherein:
collapsing the first execution bubble comprises issuing a second instruction to the ALU during the first stall condition.

5. The method of claim 2, further comprising:
stalling the third stage of the ALU in response to collapsing the first execution bubble and in response to determining the first stall condition persists at the second stage of the ALU.

6. The method of claim 1, wherein:
identifying the first execution bubble comprises identifying the first execution bubble in response to identifying an invalid instruction executing at the ALU.

7. The method of claim 1, further comprising:
identifying a second execution bubble at a third stage of an arithmetic logic unit (ALU) and a second stall condition at a fourth stage of the ALU; and
in response to identifying the second execution bubble and the second stall condition, collapsing the second execution bubble.

8. A method, comprising:
in response to detecting a first stall condition at a first stage of an arithmetic logic unit (ALU):
collapsing a first execution bubble at a second stage of the ALU by executing a first instruction at a third stage of the ALU during the first stall condition.

9. The method of claim 8, wherein:
collapsing the first execution bubble comprises executing a second instruction at a fourth stage of the ALU during the first stall condition.

10. The method of claim 9, wherein:
collapsing the first execution bubble comprises executing instructions at stages of the ALU prior to the second stage during the first stall condition.

11. The method of claim 8, wherein:
collapsing the first execution bubble comprises issuing a second instruction to the ALU during the first stall condition.

12. The method of claim 8, further comprising:
stalling the third stage of the ALU in response to collapsing the first execution bubble and in response to determining the first stall condition persists at the second stage of the ALU.

13. The method of claim 8, further comprising:
identifying the first execution bubble in response to identifying an invalid instruction executing at the ALU.

14. The method of claim 8, further comprising:
in response to detecting a second stall condition at a fourth stage of an arithmetic logic unit (ALU):
collapsing a second execution bubble at a fifth stage of the ALU by executing a second instruction at the third stage of the ALU during the first stall condition.

15. A processing unit, comprising:
an arithmetic logic unit (ALU), comprising:
a plurality of stages; and
an ALU control unit configured to:
identifying a first execution bubble at a first stage of an arithmetic logic unit (ALU) and a first stall condition at a second stage of the ALU; and
in response to identifying the first execution bubble and the first stall condition, collapsing the first execution bubble.

16. The processing unit of claim 15, wherein the ALU control unit is configured to:
collapse the first execution bubble by executing a first instruction at a third stage of the ALU during the first stall condition.

17. The processing unit of claim 16, wherein the ALU control unit is configured to:
collapse the first execution bubble by executing a second instruction at a fourth stage of the ALU during the first stall condition.

18. The processing unit of claim 16, wherein the ALU control unit is configured to:
collapse the first execution bubble by issuing a second instruction to the ALU during the first stall condition.

19. The processing unit of claim 16, the ALU control unit is configured to:
stall the third stage of the ALU in response to collapsing the first execution bubble and in response to determining the first stall condition persists at the second stage of the ALU.

20. The processing unit of claim 15, wherein the ALU control unit is configured to:
identify the first execution bubble comprises identifying the first execution bubble in response to identifying an invalid instruction executing at the ALU.
